(19) United States
(12) Patent Application Publication
(10) Pub. No.: US 2024/0252374 A1
(43) Pub. Date: Aug. 1, 2024

(54) FOOT REST

(71) Applicant: HEARTY MESSAGE CO., LTD., Kochi-shi Kochi (JP)

(72) Inventor: Yuichi SHIKICHI, Kochi-shi Kochi (JP)

(21) Appl. No.: 18/565,268

(22) PCT Filed: Jun. 10, 2022
(86) PCT No.: PCT/JP2022/023429

§ 371 Date: Nov. 29, 2023

(30) Foreign Application Priority Data
Jun. 12, 2021 (JP) 2021-098366

(51) Int. Cl. A61G 5/12

(52) U.S. Cl. CPC A61G 5/128

(57) ABSTRACT

A wheelchair foot rest (10) including a foot rest body (11) divided substantially into a first foot rest part (12) and a second foot rest part (13), that are coupled together by a coupling member. The second foot rest part is provided with a bearing part and is rotatably supported by attaching the bearing part to a foot rest post disposed on a lower end of a leg pipe of the wheelchair. A wire is inserted through an insertion hole provided to the first and second foot rest parts. One end of the wire is fixed to an end of the first foot rest part, the other end of the wire is fixed to the foot rest post. Also, a biasing device for biasing the first foot rest part and the second foot rest part in a folding direction is provided to a coupled section therebetween.

### TECHNICAL FIELD

The present invention relates to a foot rest for a wheelchair, and particularly to a foot rest that is made easy to open and close, and is hygienic.

### BACKGROUND ART

Conventionally, there have been generally used a foot rest (also referred to as a “foot plate”, “foot support”, or the like) for a wheelchair that is in a closed (raised) state by lifting an end of the foot rest upward when a user gets in and out of the wheelchair, and is in an opened (lowered) state for the user to rest his/her feet on the foot rest when the user seats in the wheelchair. The foot rest is opened and closed by caregivers squatting down to use their hands, or by the user himself/herself with his/her foot or hands. However, it is extremely unhygienic to perform the opening and closing operations of the foot rest with the hands.

In addition, the opening and closing operations of the foot rest requires relatively a strong force to prevent the foot rest from switching from a closed state to an opened state with a slight touch, for example. Therefore, the caregivers need to grasp the foot rest firmly to open and close when operating it with their hands, which is particularly unhygienic. Furthermore, a patient with impaired lower limb functions has a difficulty of operating the foot rest with his/her foot, resulting in the operation using his/her hands, which is also unhygienic.

Therefore, various types of foot rests that are made easy to open and close have been disclosed (see, for example, Patent Literatures 1 to 3). Patent Literature 1 discloses an operation mechanism for a foot rest for a wheelchair, including a first gear having on a rotating axis of the foot rest for the wheelchair, a belt or chain or wire connected to the first gear, a second gear connected to the belt or chain or wire, and an operation pin connected and fixed to the belt or chain or wire, wherein the first gear, the belt or chain or wire, the second gear, and the operation pin are configured inside a front pipe frame located on both sides below the knee of the wheelchair, and moving a head of the operation pin protruding from the front pipe frame enables the foot rest to rotationally drive upward and downward.

In addition, Patent Literature 2 discloses a wheelchair, including a foot rest having a rotating portion with low friction, a reel allowing to rotate only in one direction in a first state and in the opposite direction in a second state, a wire rope which one end of which is attached to the foot rest and the other end of which is attached to the reel, wherein a base end of the wire rope is passed through a pipe frame that constitutes a wheelchair body.

Furthermore, Patent Literature 3 discloses an opening/closing mechanism for a foot plate which is provided on support axes provided on each side of the front side of a wheelchair body, which can be rotated from a horizontal position to an upright position, wherein an elastic member is provided between a base of the foot plate and the support axes, allowing the foot plate to be maintained in the upright position when it is not used.

### CITATION LIST

### Patent Literature

Patent Literature 1: JP 2020-192022 A
Patent Literature 2: JP 2017-93710 A
Patent Literature 3: JP 2015-146863 A

### SUMMARY OF INVENTION

### Technical Problem

According to the various foot rests disclosed in the Patent Literatures 1 to 3, all of them are considered to facilitate the opening and closing operations of the foot rest using a relatively simple configuration. In particular, all of the foot rests are considered to be hygienic, since it is unnecessary directly to touch the foot rest with one's hands during the opening and closing operations.

However, the foot rests disclosed in both Patent Literatures 1 and 2 require manual operation.

In addition, when using the foot rest disclosed in Patent Literature 3, it is necessary to raise the foot to the position of an end of the foot rest which is in an erected state, which is considered to be extremely difficult for a patient with a limited range of motion in his/her joints. Furthermore, the foot rest is biased by the elastic member to maintain it in an upright position. Therefore, it is necessary for a patient to step into the foot rest with a force exceeding this biasing force, which is difficult for a patient with impaired lower limb functions. Furthermore, the operation of the foot rest disclosed in Patent Literature 3 is basically performed by a user himself/herself, which is considered to be extremely difficult for a caregiver to maintain the foot rest in a usable state.

In view of the above circumstances, the present invention has been made as a result of a series of earnest investigation by an inventor of the present application to provide a foot rest for a wheelchair that uses a simple configuration, is made extremely easy to open and close, and is hygienic, since it is unnecessary directly to touch the foot rest with one's hands.

### Solution to Problem

The present invention provides a foot rest which is provided to a wheelchair, wherein a foot rest body is divided substantially in two into a first foot rest part and a second foot rest part, that are coupled together by a coupling member, the second foot rest part is provided with a bearing part, the second foot rest part is rotatably supported by attaching the bearing part to a foot rest post disposed on a lower end of a leg pipe of the wheelchair, a wire is inserted through an insertion hole provided to the first foot rest part and the second foot rest part, one end of the wire is fixed to an end of the first foot rest part, the other end of the wire is fixed to the foot rest post, and a biasing means for biasing the first foot rest part and the second foot rest part in a folding direction is provided to a coupled section therebetween. In the foot rest according to the present invention, a wire adjustment means is further provided to the end of the first foot rest part, and the one end of the wire is fixed through the wire adjustment means.

The present invention also provides a foot rest which is provided to a wheelchair, wherein a foot rest body is divided substantially in two into a first foot rest part and a second foot rest part, that are coupled together by a coupling member, the second foot rest part is provided with a bearing part, the second foot rest part is rotatably supported by attaching the bearing part to a foot rest post disposed on a lower end of a leg pipe of the wheelchair, a wire is provided to lower surface sides of the first foot rest part and the second foot rest part, one end of the wire is fixed to the first foot rest part, the other end of the wire is fixed to the foot rest post, and a biasing means for biasing the first foot rest part and the second foot rest part in a folding direction is provided to a coupled section therebetween.

In the foot rest according to the present invention, a wire adjustment means is further provided to the lower surface side of the first foot rest part, and the one end of the wire is fixed through the wire adjustment means.

### Advantageous Effects of Invention

According to the foot rest of the present invention, it is made extremely easy to open and close with a foot, so that even a patient with impaired lower limb functions can perform the opening and closing operations of the foot rest, and it is extremely hygienic, since it is unnecessary directly to touch the foot rest with one's hands.

In particular, the foot rest body pertaining to the foot rest is divided substantially in two into the first foot rest part and the second foot rest part, and thus, the height to raise the foot may be only about half of that of a conventional foot rest when switching the foot rest from a closed state to an opened state. Therefore, it is considered that even a patient with impaired lower limb functions can relatively easily perform the opening and closing operations of the foot rest.

The foot rest of the present invention also uses a simple configuration, thus allowing to provide the foot rest with excellent operationality and being hygienic at a low cost.

Furthermore, in the foot rest of the present invention, the one end of the wire is fixed to the first foot rest part through the wire adjustment means, thus enabling easy recovery of the tension of the wire, ensuring ease of opening and closing operations of the foot rest in a long term, and firmly maintaining the opened state and the closed state over the long term.

### BRIEF DESCRIPTION OF DRAWINGS

FIG. 1 is a front view of a wheelchair provided with a foot rest according to one embodiment of the present invention.

FIG. 2A is a plan view of the foot rest shown in FIG. 1.

FIG. 2B is a bottom view of the foot rest shown in FIG. 1.

FIG. 2C is a front view of the foot rest shown in FIG. 1.

FIG. 2D is a front view illustrating a closed state of the foot rest shown in FIG. 1.

FIG. 3A is a front view illustrating a closed state of a foot rest in use according to one embodiment of the present invention.

FIG. 3B is a front view illustrating an opened state of a foot rest in use according to one embodiment of the present invention.

FIG. 4 is a plan view of a foot rest according to another embodiment of the present invention.

FIG. 5A is a plan view of a foot rest according to another embodiment of the present invention.

FIG. 5B is a bottom view of the foot rest shown in FIG. 5A.

### DESCRIPTION OF EMBODIMENTS

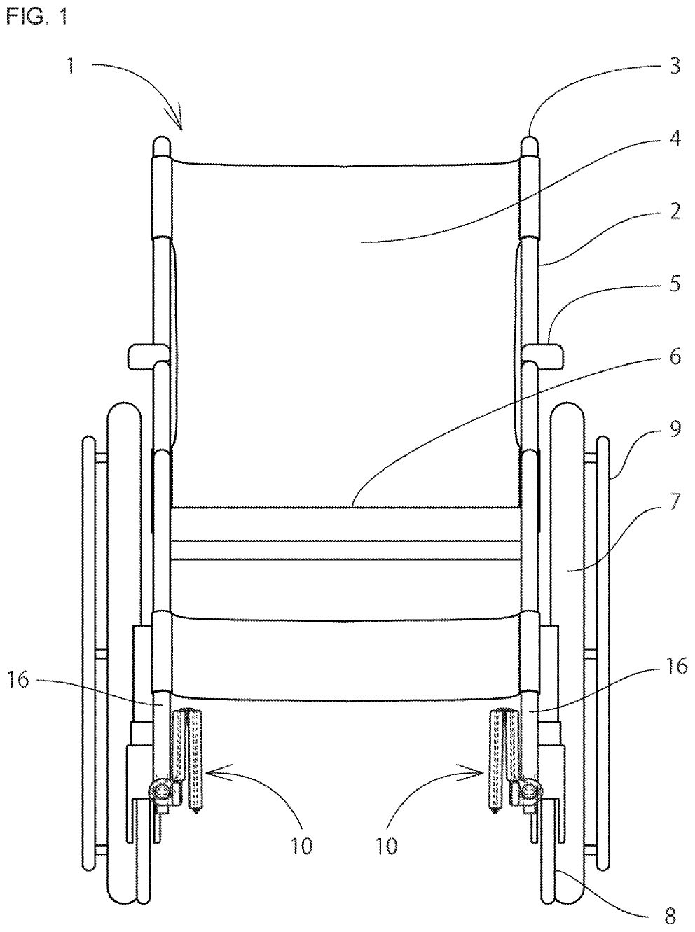

An embodiment of the foot rest of the present invention will be described in detail below based on the drawings. FIG. 1 shows a front view of a wheelchair 1 provided with a foot rest 10 according to one embodiment of the present invention. As shown in FIG. 1, the wheelchair 1 of the embodiment is almost the same to that of a general wheelchair, and is mainly configured to include a wheelchair body 2, push handles 3, a back support 4, arm supports 5, a seat 6, wheelchair wheels 7 (rear wheels), casters 8 (front wheels), hand rims 9, and the like.

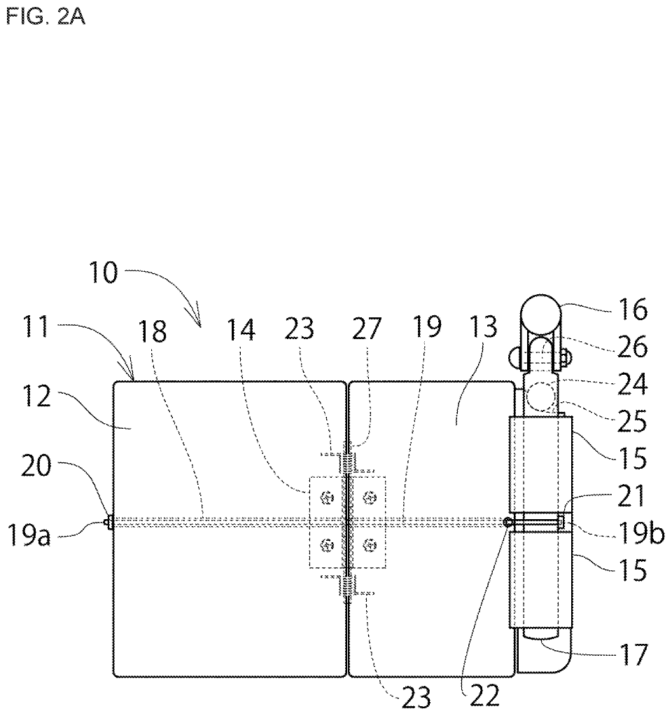

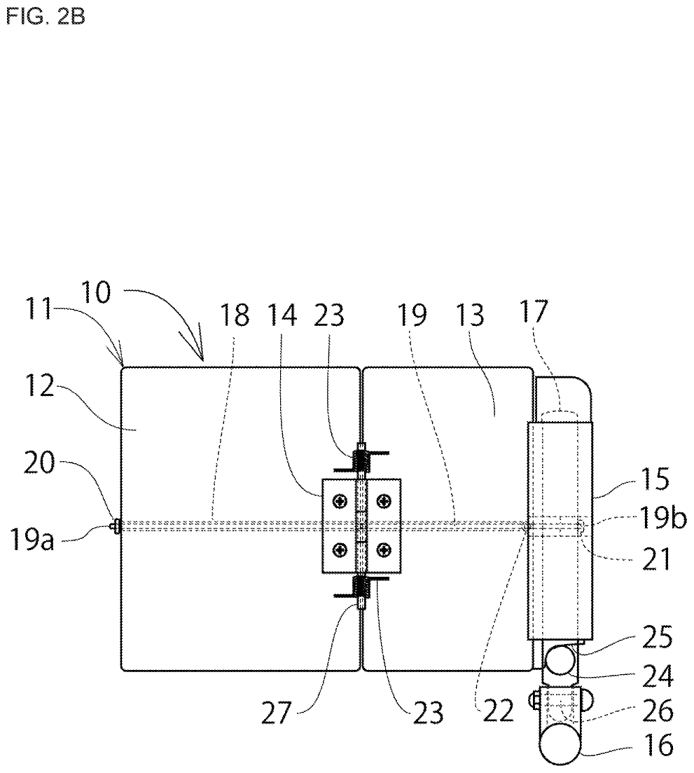

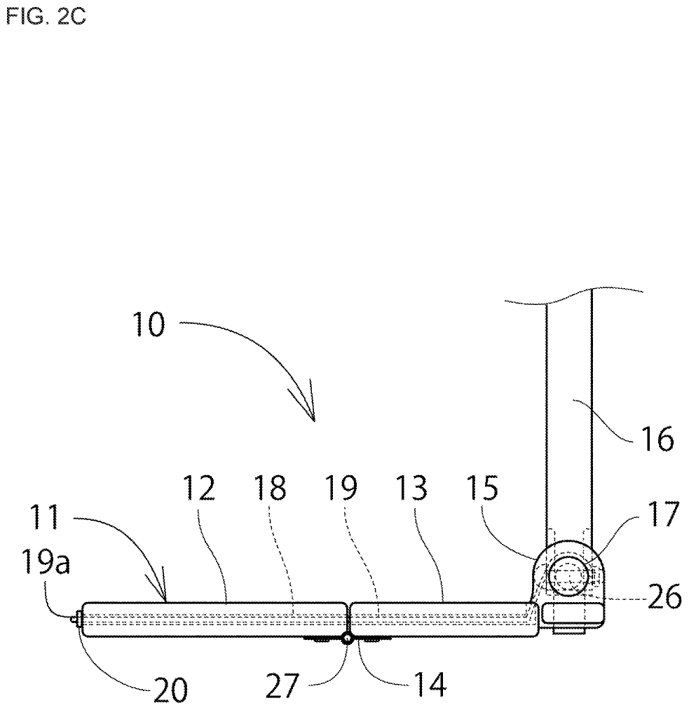

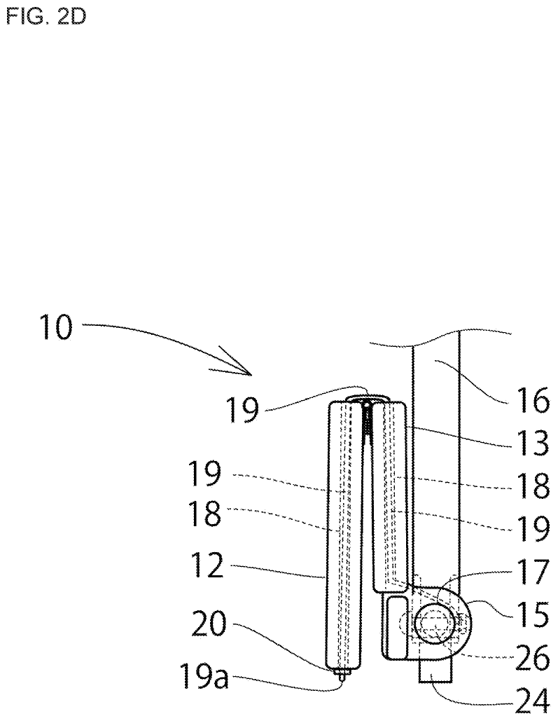

As shown in FIGS. 2A to 2D, in the foot rest 10 provided to the wheelchair 1 of the embodiment, a foot rest body 11 is divided substantially in two into a first foot rest part 12 and a second foot rest part 13, that are coupled together by a coupling member 14. Hinges, for example, can be applied to the coupling member 14, and the first foot rest part 12 and the second foot rest part 13 are foldably coupled together so as to be butted against each other by the coupling member 14 on the lower surface side of the foot rest body 11, as shown in FIG. 2B.

The second foot rest part 13 comprising the foot rest body 11 according to the embodiment includes a bearing part 15. The bearing part 15 according to the embodiment has an approximately cylindrical shape. The center in its longitudinal direction is partially notched, and a wire 19 described below is arranged in this notched portion. The second foot rest part 13 is also rotatably supported around a foot rest post 17 as a pivot axis by attaching the bearing part 15 provided to the second foot rest part 13 to the foot rest post 17 disposed on a lower end of a leg pipe 16 of the wheelchair 1 according to the embodiment.

Furthermore, the first foot rest part 12 and the second foot rest part 13 according to the embodiment are provided with an insertion hole 18 that transversely passes through the inside of each, and the wire 19 is inserted through the insertion hole 18. More specifically, one end 19a of the wire 19 is inserted into the insertion hole 18 pertaining to the second foot rest part 13 from an insertion port 22 formed in the second foot rest part 13, and is further inserted into the insertion hole 18 provided to the first foot rest part 12. The one end 19a of the wire 19 is fixed to an end of the first foot rest part 12 by a fixture 20, and the other end 19b of the wire 19 is fixed to the foot rest post 17 by a fixture 21.

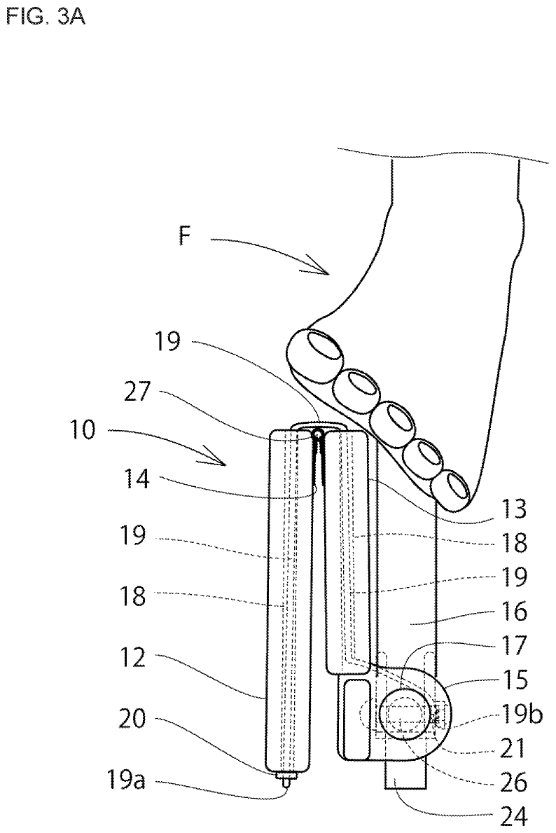

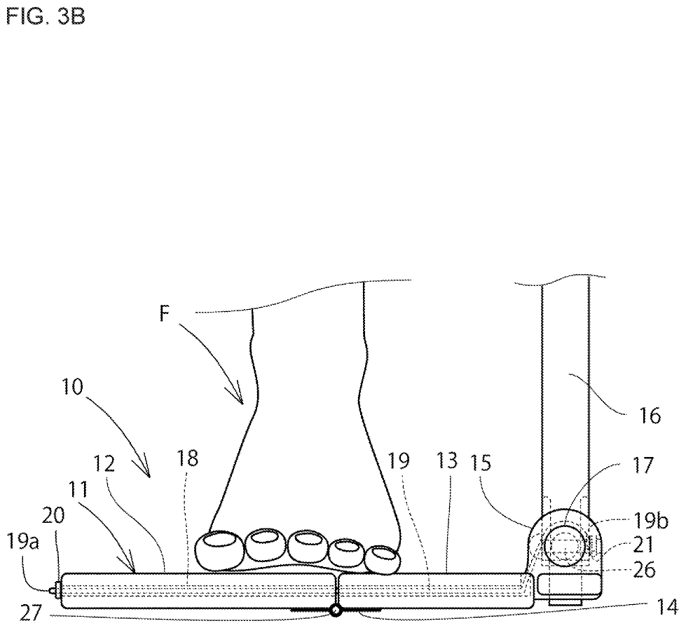

Herein, although the position of the other end 19b of the wire 19 fixed to the foot rest post 17 is not particularly limited, as shown in FIGS. 3A and 3B, when the foot rest post 17 is viewed from the front and the direction directly above is 0°, the other end 19b of the wire 19 is preferably fixed at the position of 90° in the direction opposite to the side where the foot rest body 11 (the first foot rest part 12 and second foot rest part 13) is arranged, in other words, at the position of 90° to the outside when the side where the foot rest body 11 is arranged is inside. Fixing the other end 19b of the wire 19 at this position enables the foot rest body 11 to keep more horizontal when the foot rest 10 of the embodiment is used, namely, when the foot rest 10 is in an opened state.

In addition, according to the embodiment, a biasing means 23 for biasing the first foot rest part 12 and the second foot rest part 13 in a folding direction is provided to a coupled section therebetween. The example of the biasing means 23 according to the embodiment includes, but not particularly limited to, a torsion coil spring as shown, and any biasing means that biases the first foot rest part 12 and the second foot rest part 13 in a folding direction may be used.

In the foot rest 10 of the embodiment having the above configuration, the first foot rest part 12 and the second foot rest part 13 are folded into a mountain fold at the arrangement position of the coupling member 14 when not in use, and the second foot rest part 13 is maintained in a substantially upright position (almost in parallel to a leg pipe 16), as shown in FIGS. 1 and 2D.

When using the foot rest 10, a user of the wheelchair 1 steps near the arrangement position of the coupling member 14 on the second foot rest part 13 side with his/her foot F, as shown in FIG. 3A. The second foot rest part 13 is rotatably supported around the foot rest post 17 as a pivot axis by the bearing part 15, and thus the second foot rest part 13 rotates around the foot rest post 17 as a pivot axis. At this time, one wire 19 is inserted into the respective insertion holes 18 inside of the first foot rest part 12 and the second foot rest part 13, and both ends of this wire are each fixed in the predetermined position, therefore, the end side of the first foot rest part 12 is pulled by the wire 19 to gradually open as the second foot rest part 13 is rotated, and finally the first foot rest part 12 and the second foot rest part 13 become to be aligned and opened (use) state, as shown in FIG. 3B.

Note that as shown in FIGS. 2A and 2B, the rotation of the second foot rest part 13 is regulated by a contact part 25 provided to the second foot rest part 13 abutting against a contact pipe 24 extended below the foot rest post 17, resulting in maintaining the second foot rest part 13 in a horizontal state. The end of the first foot rest part 12 coupled to the second foot rest part 13 is also pulled by the wire 19 those both ends fixed, so that the first foot rest part 12 and the second foot rest part 13 remain in the aligned and opened state without inclining the end of the first foot rest part 12 downward.

When switching the foot rest 10 from a use state (opened state) shown in FIG. 3B to a storage state (closed state) shown in FIG. 3A, around the arrangement position of the coupling member 14 disposed at the coupled section between the first foot rest part 12 and the second foot rest part 13 is lifted slightly from the back side with the foot F. Then, since the wire 19 is located above a pivot pin 27 of the coupling member 14, the wire 19 lifted by the pivot pin 27 causes the first foot rest part 12 and the second foot rest part 13 to be folded by a biasing force of the biasing means 23, and the wire 19 pulls the end side of the first foot rest part 12, thereby the second foot rest part 13 is rotated accordingly to be finally in the storage (closed) state shown in FIG. 3A.

As described above, the foot rest 10 according to the embodiment is made extremely easy to open and close with the foot F, so that even a patient with impaired lower limb functions can perform the opening and closing operations of the foot rest 10, and it is extremely hygienic, since it is unnecessary directly to touch the foot rest 10 with one's hands.

In particular, the foot rest body 11 pertaining to the foot rest 10 of the embodiment is divided substantially in two into the first foot rest part 12 and the second foot rest part 13, so that the height at which the foot F is raised may be about one-half that of a conventional foot rest when switching the foot rest 10 from the closed state to the opened state, as shown in FIG. 3A. Therefore, it is considered that even a patient with impaired lower limb functions can relatively easily perform the opening and closing operations of the foot rest 10.

In addition, the foot rest 10 of the embodiment uses a simple configuration, thus allowing to provide the foot rest 10 with excellent operationality and being hygienic at a low cost.

Furthermore, when the foot rest 10 of the embodiment is in the opened state shown in FIG. 3B, it can maintain a horizontal state even when the foot F is not placed on it. In other words, even if it is difficult for the user to perform the opening and closing operations of the foot rest 10 by himself/herself, a caregiver can open and close it with one's foot. For example, the caregiver can switch the foot rest 10 from the closed state to the opened state, and the user can place his/her feet after the caregiver removes the foot.

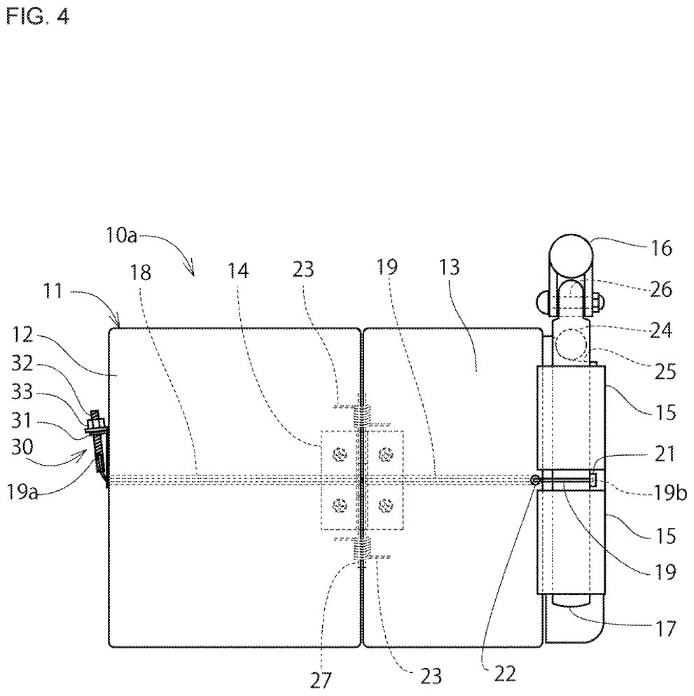

Although the foot rest 10 according to one embodiment of the present invention has been described in detail above, the embodiment of the present invention is not limited thereto. A foot rest 10a according to another embodiment of the present invention, shown in FIG. 4, has the same basic configuration as the foot rest 10 according to the embodiment described above.

In the foot rest 10a of the embodiment, the one end 19a of the wire 19 inserted into the foot rest body 11 is fixed through a wire adjustment means 30 disposed on the end of the first foot rest part 12 pertaining to the foot rest body 11. The wire adjustment means 30 has a threaded rod 32 disposed on a base 31 attached and fixed to the end of the first foot rest part 12, and a nut 33 screwed onto the threaded rod 32. The one end 19a of the wire 19 is attached and fixed near an end of the threaded rod 32, and the threaded rod 32 is configured to move back and forth by turning the nut 33. Therefore, when the wire 19 becomes stretched due to continuous use of the foot rest 10a of the embodiment, or the like, the nut 33 is turned in the direction to retract the threaded rod 32 pertaining to the wire adjustment means 30. As a result, the one end 19a of the wire 19 is pulled in the opposite direction of the other end 19b as the threaded rod 32 retracts, so that recover of the tensile force of the wire 19 is achieved.

As described above, according to the foot rest 10a of the embodiment, even if the wire 19 becomes stretched due to continuous use of the foot rest 10a, or the like, the tensile force of the wire 19 can be recovered, therefore, the ease of opening and closing operations of the foot rest 10a can be secured in a long term, and the opened state and closed state can be firmly maintained over the long term.

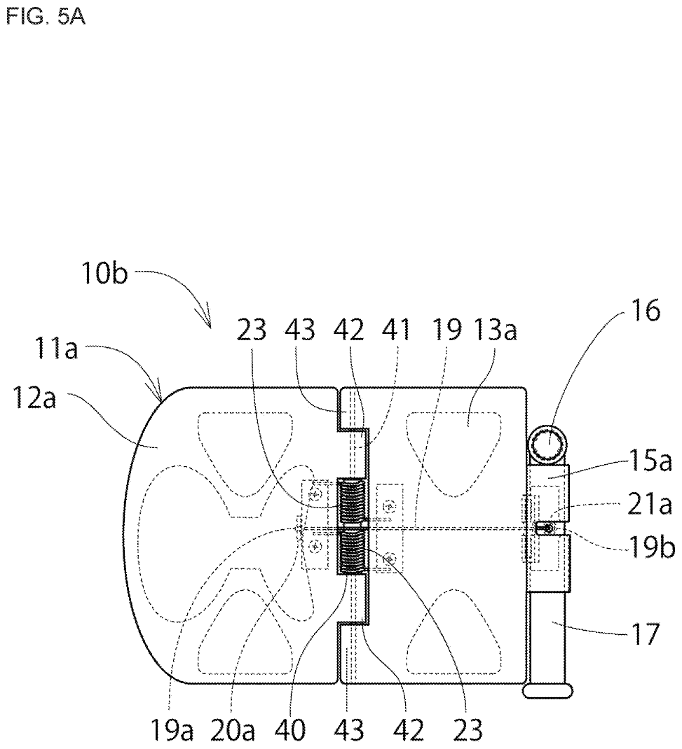

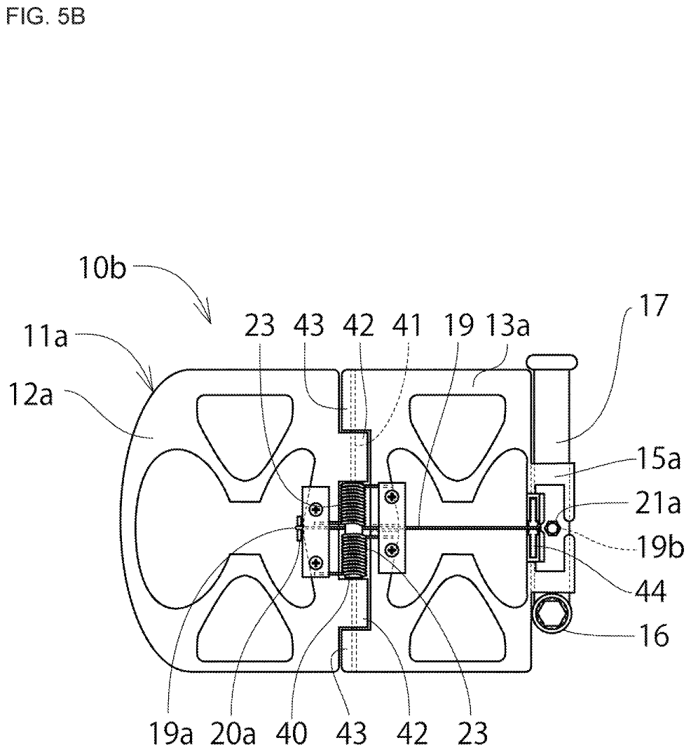

Then, according to further another embodiment of the present invention, in a foot rest 10b shown in FIGS. 5A and 5B, a foot rest body 11a is divided substantially in two into a first foot rest part 12a and a second foot rest part 13a, that are rotatably coupled together by a coupling member 41. More specifically, the first foot rest part 12a and the second foot rest part 13a are foldably coupled by inserting the coupling member 41 (coupling pin) into a coupling bearing part 42 provided to the first foot rest part 12a and a coupling bearing part 43 provided to the second foot rest part 13a.

The second foot rest part 13a comprising the foot rest body 11a pertaining to the foot rest 10b of the embodiment also includes a bearing part 15a. The bearing part 15a according to the embodiment also has an approximately cylindrical shape, and the center in its longitudinal (axial) direction is partially notched. The wire 19 described below is arranged in this notched portion.

The foot rest 10b of the embodiment is also attached to the wheelchair 1 according to the aforementioned embodiment. The second foot rest part 13a is rotatably supported around the foot rest post 17 as a pivot axis by attaching the bearing part 15a provided to the second foot rest part 13a to the foot rest post 17 disposed on the lower end of the leg pipe 16 of the wheelchair 1.

Furthermore, as shown in FIG. 5B, the wire 19 is arranged on lower surface sides of the first foot rest part 12a and the second foot rest part 13a according to the embodiment. More specifically, the one end 19a of the wire 19 is inserted from the notched portion of the bearing part 15a pertaining to the second foot rest part 13a to the lower surface side of the second foot rest part 13a. Then, the one end 19a of the wire 19 is arranged from the lower surface side of the second foot rest part 13a to the lower surface side of the first foot rest part 12a. The one end 19a of the wire 19 is fixed to the lower surface side of the first foot rest part 12a by a fixture 20a, and the other end 19b of the wire 19 is fixed to the foot rest post 17 by a fixture 21a.

Herein, the position or method for fixing the other end 19b of the wire 19 pertaining to the foot rest 10b of the embodiment to the foot rest post 17 is not particularly limited, and may be fixed in the same position as the foot rest 10, 10a of the aforementioned embodiment. However, for example, the other end 19b of the wire 19 may be penetrated from directly above the foot rest post 17 to directly below the foot rest post 17 when viewed from the front, as shown in FIG. 5A, and the other end 19b may be fixed to the lower surface side of the foot rest post 17 by the fixture 21a, as shown in FIG. 5B. Fixing the other end 19b of the wire 19 to the lower surface side of the foot rest post 17 using the fixing method enables the foot rest body 11 to be maintained in a horizontal state when the foot rest 10b of the embodiment is used, namely, when the foot rest 10b is in the opened state.

According to the embodiment, the biasing means 23 for biasing the first foot rest part 12a and the second foot rest part 13a in a folding direction is provided to the coupled section 40 therebetween. The example of the biasing means 23 according to the embodiment includes, but not particularly limited to, the torsion coil spring shown in FIGS. 5A and 5B in a similar way to the foot rests 10, 10a of the aforementioned embodiments, and any biasing means that biases the first foot rest part 12a and the second foot rest part 13a in a folding direction may be used.

Note that in the foot rest 10b of the embodiment, the wire 19 is inserted from the notched portion of the bearing part 15a pertaining to the second foot rest part 13a to the lower surface side of the second foot rest part 13a, and a wire receiving member 44 is arranged at the insertion position of the wire 19 on the lower surface side of the second foot rest part 13a. Arranging the wire receiving member 44 enables the opening and closing operations of the foot rest 10b to be performed more smoothly.

In the foot rest 10b of the embodiment, the one end 19a of the wire 19 is also preferably fixed to the lower surface side of the first foot rest part 12a through a wire adjustment means. A similar configuration to the wire adjustment means 30 pertaining to the foot rest 10a of the embodiment described above can be applied to the wire adjustment means. However, for a simpler configuration, for example, applying a screw member to the fixture 20a and winding and fixing the one end 19a of the wire 19 enable the tensile force of the wire 19 to be easily recovered even if the wire 19 is stretched.

In the foot rest 10b of the embodiment having the above configuration, the first foot rest part 12a and the second foot rest part 13a are also folded into a mountain fold at the arrangement position of the coupling member 41, and the second foot rest part 13b is maintained in a substantially upright position (almost in parallel to the leg pipe 16) when not in use in a similar way to the foot rest 10 shown in FIGS. 1 and 2D.

When using the foot rest 10b, a user of the wheelchair 1 steps near the arrangement position of the coupling member 41 on the second foot rest part 13a side with his/her foot F in a similar way to the foot rest 10 shown in FIG. 3A. The second foot rest part 13a is rotatably supported around the foot rest post 17 as a pivot axis by the bearing part 15a, and thus the second foot rest part 13a rotates around the foot rest post 17 as a pivot axis. At this time, the wire 19 is arranged in the first foot rest part 12a and the second foot rest part 13a, and both ends of this wire 19 are each fixed in the predetermined position, therefore, the one end 19a side of the wire 19 pertaining to the first foot rest part 12a is pulled by the wire 19 to gradually open as the second foot rest part 13a is rotated, and finally the first foot rest part 12a and the second foot rest part 13a become to be aligned and opened (use) state in a similar way to the state shown in FIG. 3B.

Note that the rotation of the second foot rest part 13a is regulated by the second foot rest part 13a abutting against the leg pipe 16, resulting in maintaining the second foot rest part 13a in a horizontal state. The first foot rest part 12a coupled to the second foot rest part 13a is also pulled by the wire 19 those both ends fixed, so that the first foot rest part 12a and the second foot rest part 13a remain in the aligned and opened state without inclining the end of the first foot rest part 12a downward.

In addition, when switching the foot rest 10b of the embodiment from a use state (opened state) to a storage state (closed state), around the arrangement position of the coupling member 41 disposed at the coupled section 40 between the first foot rest part 12a and the second foot rest part 13a is lifted slightly from the lower surface side with the foot. Then, since the wire 19 is located above the coupling member 41, the wire 19 lifted by the coupling member 41 causes the first foot rest part 12a and the second foot rest part 13a to be folded by a biasing force of the biasing means 23, and the wire 19 pulls the first foot rest part 12a, so that the second foot rest part 13a is rotated accordingly to be finally in the storage (closed) state.

According to the foot rest 10b of the embodiment with the above configuration, it is made extremely easy to open and close the foot rest 10b with the foot, so that even a patient with impaired lower limb functions can perform the opening and closing operations of the foot rest 10b, and it is extremely hygienic, since it is unnecessary directly to touch the foot rest 10b with one's hands.

In particular, the foot rest body 11a pertaining to the foot rest 10b of the embodiment is also divided substantially in two into the first foot rest part 12a and the second foot rest part 13a, so that the height at which the foot is raised may be about one-half that of a conventional foot rest when switching the foot rest 10b from the closed state to the opened state. Therefore, it is considered that even a patient with impaired lower limb functions can relatively easily perform the opening and closing operations of the foot rest 10b. Other effects similar to those of the foot rests 10, 10a of the aforementioned embodiments can be obtained.

The embodiments of the foot rest of the present invention have been described in detail above. However, they should not be interpreted as substantially limiting the technical idea of the present invention. For example, in the foot rests 10, 10a, 10b according to the embodiments of the present invention, the foot rest post 17 may be directly fixed to the leg pipe 16, or may be rotatably coupled and fixed around a pivot pin 26 as a pivot axis, as shown in each drawing. Rotatably coupling and fixing the foot rest post 17 to the leg pipe 16 enables the foot rests 10, 10a, 10b to be further rotated from the closed state such that the foot rest post 17 is almost in parallel to the leg pipe 16, and thus, the foot rests 10, 10a, 10b can be more compactly stored. The present invention can be implemented with improvements, modifications or additions as appropriate by the ingenuity of those skilled in the art without departing from the scope of the present invention.

### LIST OF REFERENCE SIGN

1 wheelchair
2 wheelchair body
3 push handle
4 back support
5 arm support
6 seat
7 wheelchair wheel
8 caster
9 hand rim
10, 10a, 10b foot rest
11, 11a foot rest body
12, 12a first foot rest part
13, 13a second foot rest part
14, 41 coupling member
15, 15a bearing part
16 leg pipe
17 foot rest post
18 insertion hole
19 wire
20, 20a, 21, 21a fixture
22 insertion port
23 biasing means
24 contact pipe
25 contact part
26, 27 pivot pin
30 wire adjustment means
31 base
32 threaded rod
33 nut
40 coupled section
42, 43 coupling bearing part
44 wire receiving member

1. A foot rest which is provided to a wheelchair, wherein
a foot rest body is divided substantially in two into a first foot rest part and a second foot rest part, that are coupled together by a coupling member,
the second foot rest part is provided with a bearing part,
the second foot rest part is rotatably supported by attaching the bearing part to a foot rest post disposed on a lower end of a leg pipe of the wheelchair,
a wire is inserted through an insertion hole provided to the first foot rest part and the second foot rest part,
one end of the wire is fixed to an end of the first foot rest part,
the other end of the wire is fixed to the foot rest post, and
a biasing means for biasing the first foot rest part and the second foot rest part in a folding direction is provided to a coupled section therebetween.

2. The foot rest of claim 1, wherein
a wire adjustment means is provided to the end of the first foot rest part, and
the one end of the wire is fixed through the wire adjustment means.

3. A foot rest which is provided to a wheelchair, wherein
a foot rest body is divided substantially in two into a first foot rest part and a second foot rest part, that are coupled together by a coupling member,
the second foot rest part is provided with a bearing part,
the second foot rest part is rotatably supported by attaching the bearing part to a foot rest post disposed on a lower end of a leg pipe of the wheelchair,
a wire is provided to lower surface sides of the first foot rest part and the second foot rest part,
one end of the wire is fixed to the first foot rest part,
the other end of the wire is fixed to the foot rest post, and
a biasing means for biasing the first foot rest part and the second foot rest part in a folding direction is provided to a coupled section therebetween.

4. The foot rest of claim 3, wherein
a wire adjustment means is provided to the lower surface side of the first foot rest part, and
the one end of the wire is fixed through the wire adjustment means.
